(19) United States
(12) Patent Application Publication
(10) Pub. No.: US 2012/0272528 A1
(43) Pub. Date: Nov. 1, 2012

(54) PILL PEN WITH A PILL CUTTER AND GRINDER

(75) Inventor: Richard Qi Li, Ocala, FL (US)

(73) Assignee: Richard Qi Li, Ocala, FL (US)

(21) Appl. No.: 13/329,185

(22) Filed: Dec. 16, 2011

Related U.S. Application Data
(60) Provisional application No. 61/457,594, filed on Apr. 27, 2011.

(51) Int. Cl. A61J 7/00; B25F 1/00

(52) U.S. Cl. 30/124

(57) ABSTRACT

The pill container is shaped like a conventional pen and is composed of multiple cylindrical compartments and a cap. Each compartment is labeled for the medication it contains. The label can be placed outside or attached inside with a clip. Such labeling with a clip can be applied to the regular medication organizers to add extra function as a labeled pill container. The last compartment of pill pen has a blade embedded at its end and functions as a pill cutter, which is covered with a safety cap, which has a serrated convex surface so as to function as a pill grinder. The cutting and grinding surface is the inside vertex of the cap of the pill pen.

### BACKGROUND OF INVENTION

The pill pen of my design is a secure and convenient way to carry daily medications as well as a pleasant and constant reminder to take medications, as a patient just has to fasten the pill pen in the shirt pocket under his or her nose. It is perfectly suitable for those who are active and mobile and may not remember to take their medications on time.

The pill pen is composed of multiple cylindrical compartments, which are screwed together, and a cap. It includes the first compartment which engages the cap with interlocking ridges, the last compartment which has a cutting blade and grinder, and the rest in the middle section, which are exchangeable in position. The cap has an inside concave surface for cutting and grinding a pill. Each compartment has a dedicated area on its surface for a label, which is preferably removable or erasable and may contain the very basic information, such as the partial name of the medication and the frequency of taking it a day (such as “3×”; “4×”).

The compartments of the pill pen comes in two or three sizes, for example, the short, medium and long. A pill pen preferably has five compartments of short, medium and long length to accommodate pills of various size and quantities to be taken in a week. Whenever a patient takes a pill from the pill pen, he or she is automatically reminded of the other pills to be taken and the schedules of taking them. Its compact size and flexibility make it a very convenient medication carrier and eliminates the clutter of medicine bottles.

The disadvantage of the available medication organizers is that all different medications are mixed together in one compartment without any label, which makes it impossible for anyone to identify each medication, even so for the patients themselves and the physicians.

When a patient develops low blood pressure due to anti-hypertensives or low blood sugar due to diabetic medication, he or she may not be aware of the culprit medications that should be adjusted or discontinued, because none of the medications is labeled in the medication organizer. The patient may continue to take the same concoction of unlabeled medications until more adverse outcome happens, such as fainting resulted from low blood pressure or low blood sugar.

Medication organizers typically have AM and PM partitions for medications. In fact, many medications need to be taken three times a day or even four times a day or taken only as needed at certain intervals (for example, every 4 to 6 hours as needed). Therefore, AM/PM partition is of little use and is actually problematic for such scheduling. Some medication organizers do have four partitions for the morning, noon, afternoon and bedtime dosing. However, only some of the medications need to be taken four times a day. Therefore, the space in such medication organizers is under-utilized. The four partitions for each day make the medication organizers bulky, too.

The designs of medication organizers limit the supply of medications to one week only, Monday through Sunday, while the space in each chamber is fixed, which could be either redundant or insufficient. On the contrary, the pill pen, with each compartment filled up, can satisfy the need of medications for one week and beyond.

The pill pen with separate and labeled compartment for each kind of medication, ensures error-free administration of medications. Each compartment can be filled to the full capacity with medication, making efficient use of the space. Therefore, medication carrier like the pill pen is superior to the medication organizers.

It makes good economical sense and it is a very common practice for patients to obtain tablets in higher dosage and then take only half a tablet each time. Very often, the tablets of higher dosage may not cost much more than or even cost the same as the those of lower dosage.

Truly all-in-one, the self-contained pill cutter, pill grinder, cutting and grinding surface maximize the utility features that a pill container can possibly possess and meet all the special needs that may arise when a patient has to process his or her medications before taking them. The same is true for a caregiver who has to cut and grind medication for a patient in his or her care, who may be too sick to swallow a whole pill.

The pill cutter cuts a pill inside of the cap for the pen, so does the pill grinder. Hands are free from the pill when it is cut. Not even the smallest bit of a pill can be spilled when it is ground. The concave cutting surface inside of the cap ensures that any pill with a convex surface will be naturally centered while the inside wall of the cap along with the ridges guide and center the pill pen with the blade when cutting is performed. Therefore, it is a fool-proof, safe and accurate way to split a pill into equal halves.

Many pills are small and less than a quarter inch in diameter. When such a small pill is ground by a conventional pill grinder, almost all the ground medication is stuck between the grinding teeth on the two grinding surfaces. Even with effort to recover the ground medication, it is unlikely to recover the pill in its entirety. Even a loss of small amount accounts for a significant portion of a small pill and compromises the efficacy. The smaller and single grinding surface of the pill pen is an advantage in that it minimizes the loss of ground medication. To minimize the loss of medication from grinding, many people choose to crush a pill into small pieces rather than pulverize it. The cutter and grinder of the pill pen is ideal to accomplish this purpose.

Again, because of the very fact that many pills are made very tiny in size, it is considerably more accurate to split a very small pill with a blade on a handle under direct visualization as embodied in this design than with a hinged pill cutter while the small pill is out of sight when being cut. Sometimes, a pill needs to be cut into quarters, a task which has to be performed with a cutter similar to the one embodied by the pill pen.

Because of the fact that pill grinder is rarely used, a version without pill grinder is presented, in which both ends of the pill pen are flat and the concave cutting surface in the cap remains the same.

Another version of pill pen is composed of multiple compartments of equal length. If one compartment is not big enough to hold certain medication for one-week supply due to its bigger size and the more frequency to be taken, one additional compartment can be used to hold that medication and then labeled. In contrast to the label on the surface, I have designed a very user-friendly method to label a compartment from the inside. It is an elastic clip of square or rectangular shape and is made from metal strip, metal wire or plastic, which presses the label against the interior wall of an compartment. The customer just makes a paper label for each medication and insert it between the clip and the interior wall of the compartment. The label with its information can be seen through the transparent wall.

Such labeling method can be automatically applied to any other kind of pill containers/organizers. Such design is significant in that it expands the functions of the conventional pill containers/organizers, so that they can be used as a weekly pill organizers as well as a container for multiple individual medications when labels are inserted. In the latter case, each compartment is filled up to make the full use of its space. If necessary, more than one compartment of the conventional pill container can be labeled and used for a single medication so as to provide such medication for a week or for a period as long as necessary. Therefore, the labeling method remedies the flaws associated with the pill organizers as mentioned above.

### SUMMARY OF THE INVENTION

The pill pen is a composed of two or more cylindrical compartments which are screwed together sequentially by means of spiral threads on each compartment. Each compartment is intended to hold a single kind of medication of at least one-week supply and each compartment has a dedicated area on its surface for labeling. The compartments are variable in their lengths so as to accommodate pills which are variable in size and quantities to be taken for a week and beyond.

A cap is slipped onto the joined cylindrical compartments and is engaged to the first cylindrical compartment by means of ridges on the inside wall of the cap and on the outside wall of the first compartment, which interlock.

The last cylindrical compartment has a blade embedded in its terminal segment. A small cap is screwed on to the terminal segment of the last compartment as a safety cover for the sharp blade. In addition, a plastic sheath is slipped onto the blade for added safety. This safety cap has a finely serrated surface on its vertex and functions as a pill grinder to crush a pill against the inside concave surface of the cap of the pill pen. The safety cap has multiple vertical ridges or notches on its convex surface for easy gripping. The customers may choose not to use the compartment with a blade and screw the safety cap onto any other compartment.

In the second simpler version, the pill pen has no grinder, because grinder is rarely used. Therefore, the safety cap for the blade has a flat end and the pill pen can stand on its end.

In third version, the compartments are of the same length and more than one compartment can be labeled and used for an individual medication if more space is needed. A self-made label is attached to the interior wall of each compartment by virtue of an elastic clip and its content is visible through the container. Such labeling method can be applied to the regular pill organizers and confers them the dual functions both as a weekly pill organizer and as pill containers for multiple individual medications.

### BRIEF DESCRIPTION OF THE DRAWINGS

FIG. 1 is the exploded view of the two-compartment pill pen with a cap, pill cutter and pill grinder.

FIG. 2 is the side view of the two-compartment pill pen with a cap, pill cutter and pill grinder.

FIG. 3 is the exploded view of the five-compartment pill pen with a cap, pill cutter and pill grinder.

FIG. 4 is the side view of the five-compartment pill pen with a cap, pill cutter and pill grinder.

FIG. 5 is side view of the five-compartment pill pen with a pill cutter in the action of cutting a pill on the concave cutting and grinding surface inside of the cap of the pill pen.

FIG. 6 is the side view of the five-compartment pill pen with a cap and pill cutter only, without a grinder.

FIG. 7 is exploded view of a five-compartment pill pen with the internal clips for the labels and pill cutter.

FIG. 8 is amplified view of an internal clip of the pill pen, which is fastened onto the floor of the compartment with screws.

FIG. 9 shows the internal clip installed onto one of the covers of a regular pill organizer.

### DETAILED DESCRIPTION OF THE INVENTION

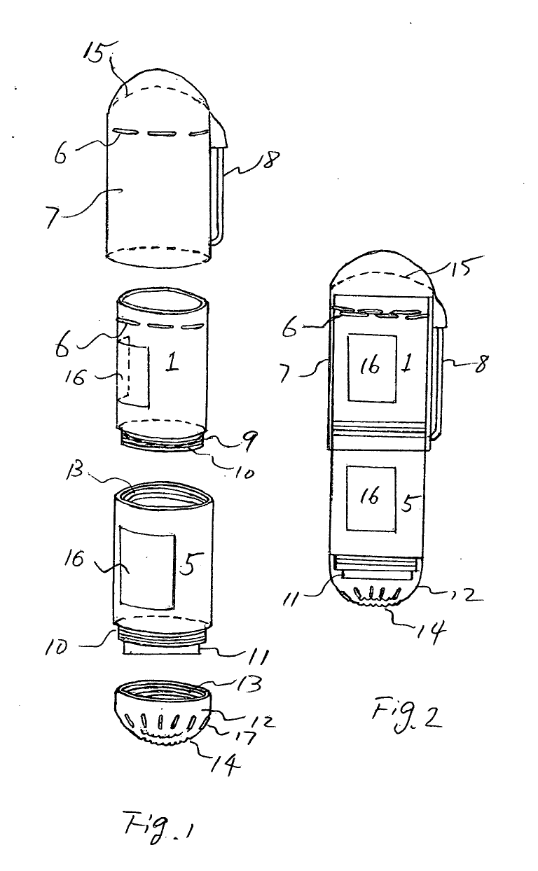

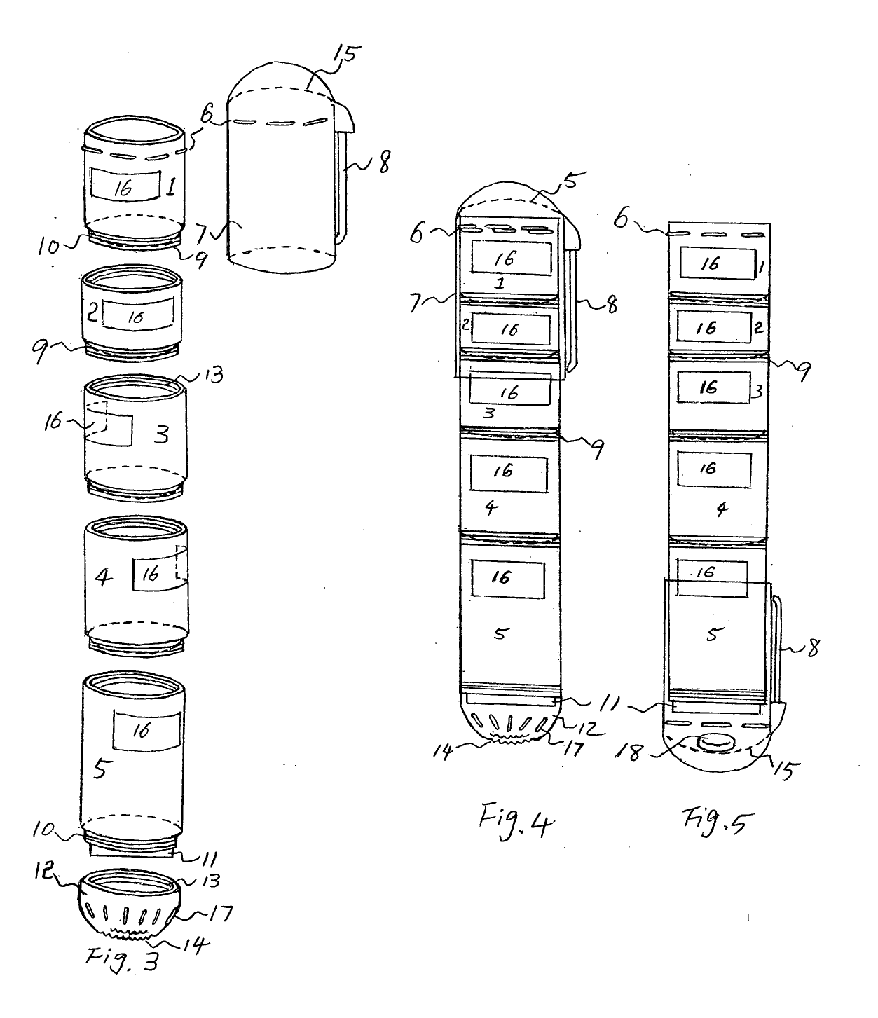

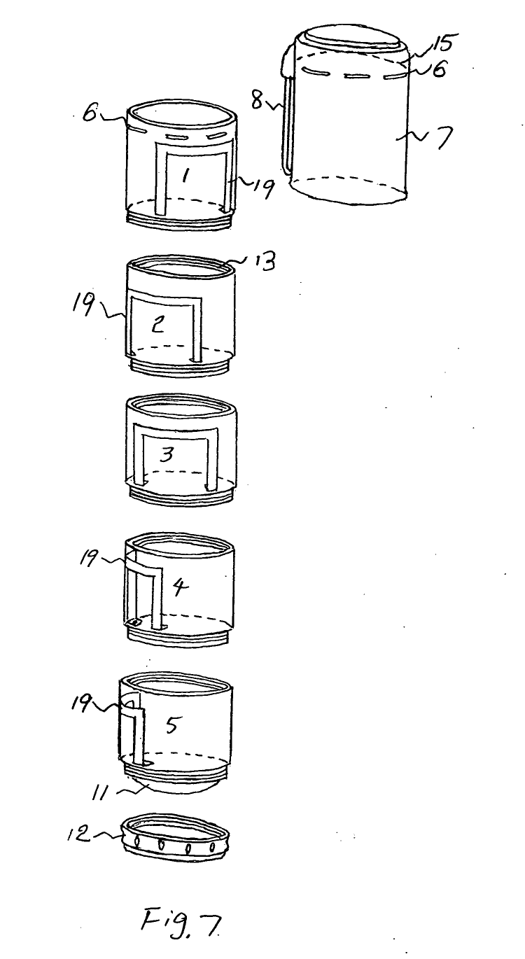

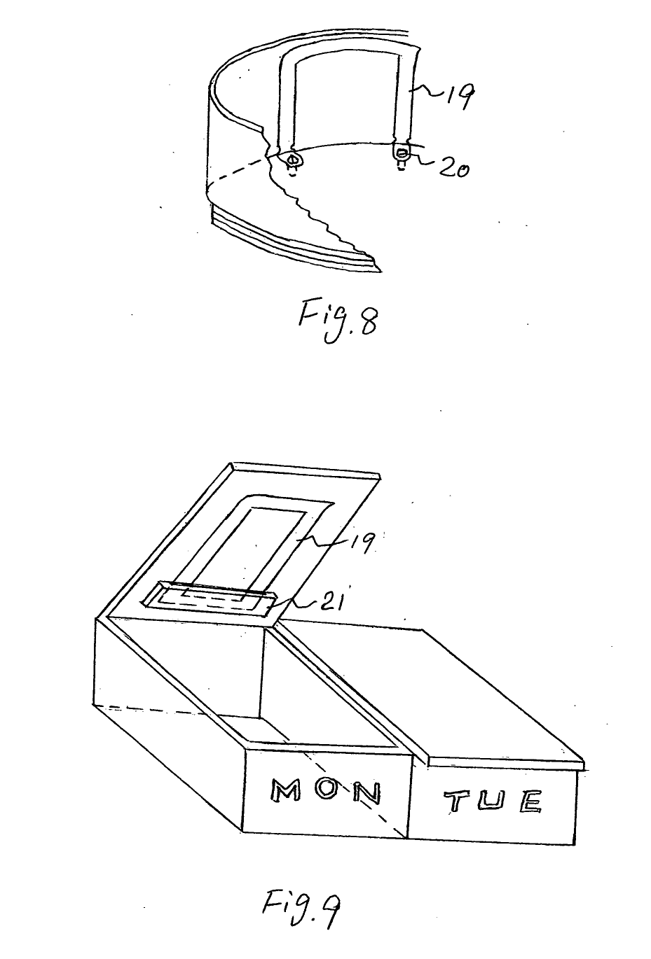

The pill pen shown in FIGS. 1 to 7 is composed of multiple cylindrical compartments. They are sequentially screwed together by means of spiral threads 10 on the terminal segment of each compartment and the spiral threads 13 inside of the opening of the subsequent compartment. Each compartment holds a single kind of medication of at least one-week supply. The lengths of the compartments are variable (for example, short, medium and long as depicted in the figures), to accommodate the various sizes and quantities of medications to be taken for at least a week. Each compartment has a dedicated surface for label 16, which is preferably removable or erasable.

The bottom of chamber 9 inside of each compartment extends into the terminal segment with spiral threads 10 so as to maximize its holding capacity for pills, with the exception of the last compartment 5, which has the cutting blade 11 embedded in the terminal segment.

The cap 7 is engaged to the first compartment 1 by means of ridges 6 on the inside wall of the cap and the ridges on the outside wall of the first compartment 1, which interlock. The reason to use ridges instead of spiral threads to attach the cap to the pill pen is to avoid the possible jamming of the spiral threads which would cause considerable difficulty to extract the first compartment 1 from inside of the cap 7. The cap has a mental clip 8 to fasten the pill pen to a desirable spot, such inside a shirt pocket or a carry bag.

The terminal segment of the last compartment 5 with a embedded cutting blade 11 is covered with a safety cap 12 to prevent accidental injury by cutting. This terminal segment with the spiral thread and the blade is preferably longer than that of the other compartment, so that the safety cap won't fall off easily to expose the blade. The safety cap 12, with spiral threads inside of its opening 13, is screwed on to the terminal segment, which has both spiral threads and a cutting blade 11. The safety cap 12 has multiple vertical ridges or notched 17 on its convex outside surface for easy gripping. The safety cap 12 can be screwed on to any other compartment if a customer chooses not to use the one with a blade.

The safety cap 12 has a finely serrated surface 14 on its vertex, by virtue of which the safety cap also functions as a pill grinder to grind a pill 18 against the inside concave cutting and grinding surface 15 of the cap 7 of the pill pen.

As shown in FIG. 5, with the safety cap 12 removed and the cutting blade 11 exposed, the pill pen is inserted into its cap, which stands on its end vertically. As almost all the pills have a convex surface (except the bar-shaped pills), such a pill will be naturally centered on the concave cutting and grinding surface 15 inside of the cap. Meanwhile, the inside wall of the cap along with the ridges on it will keep the pill pen centered inside of the cap. Therefore, it is ensured that a pill 18 will be split equally in the middle. A pill can also be chopped repeatedly into smaller pieces before grinding.

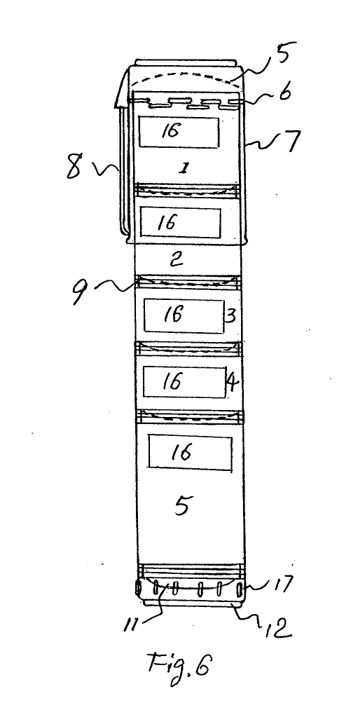

FIG. 6 demonstrates a pill pen without a grinder, as grinder is rarely used. The safety cap for the blade has a flat end, so that the pill pen can stand on its end.

In another version, the compartments are of equal length. More than one compartments can be used to hold a single medication if more space is needed. To easily identify each medication, a self-made label (not shown) is attached to the interior wall of each compartment with the use of a square or rectangular clip 19, which is made from elastic materials such as metal strips, metal wires or plastic. The foot part of the clip is fastened onto the floor of the compartment with screws 20. Preferably each foot part of the clip sits in an impression in the floor surface. The top part of the clip is slightly lifted away from the wall of the compartment.

Such labeling method can be automatically applied to any other kind of pill containers/organizers and expands its functions. Besides its customary use as a weekly pill organizer, the labeling enables it to function as a container for multiple individual medications. In the latter scenario, a clip, which can be a square or rectangular metal strip or metal wire, is inserted into its base 21 on the cover of a regular pill organizer. If it is a metal wire, coil is created on each side to increase tension. If it is plastic, the clip can be an integral part of the base. The metal strip or wire can be taken out to adjust its tension which is exerted inside the base and onto the cover.

The pill pen is made from rigid, impermeable, semi-transparent or transparent material, such as plastic, so that the medications inside are visible. The surface may be decorated with relief patterns to attenuate the spiral threads and division lines between the compartments and facilitate gripping.

What is claimed is:

1. the pill pen is a novel type of pill container and carrier, which is comprised of multiple cylindrical compartments, is incorporated with a pill cutter and a pill grinder and is covered with a cap.

2. the pill pen according to claim 1, wherein the cylindrical compartments are variable in length and exchangeable in position (except the first and last ones). Each compartment is intended to contain a single kind of medication for at least one week supply.

3. the pill pen according to claim 2, wherein each cylindrical compartment has dedicated surface for labeling.

4. the inside chamber of each said compartment extends into its terminal segment which has spiral threads, to maximize the holding capacity (except the terminal segment embedded with the cutting blade).

5. the said pill pen has a cap, which is slided over the first compartment and covers its opening.

6. the pill pen according to claim 5, wherein the said cap has a concave inside vertex, which is used for pill cutting and grinding.

7. the said cap of the pill pen is engaged to the first compartment by means of interlocking ridges on both members.

8. the said cap of the pill pen has a metal clip for it to fasten on a shirt pocket or secure to any other desirable location, such as inside a carry bag.

9. a cutting metal blade is embedded in the terminal segment of the last compartment and functions as a pill cutter.

10. the pill pen according to claim 9, wherein a safety cover is screwed on to the terminal segment to cover the blade.

11. the said safety cover, according to claim 10, can also be suitably screwed on to the terminal segment of any other compartment.

12. the said safety cover has a finely serrated surface on its vertex and functions as a pill grinder. The said safety cap also has vertical ridges or notches on its convex surface for easy gripping.
